(19) United States
(12) Patent Application Publication
(10) Pub. No.: US 2019/0333168 A1
(43) Pub. Date: Oct. 31, 2019

(54) SUBSCRIPTION BASED GAS DISCOUNT SYSTEM FOR A FUEL DISPENSER

(71) Applicant: Michael A. Racusin, Chicago, IL (US)

(72) Inventor: Michael A. Racusin, Chicago, IL (US)

(21) Appl. No.: 16/509,003

(22) Filed: Jul. 11, 2019

Related U.S. Application Data
(63) Continuation-in-part of application No. 16/136,505, filed on Sep. 20, 2018.
Application No. 16/136,505 is a continuation-in-part of application No. PCT/US2018/040020, filed on Jun. 28, 2018.
Application No. PCT/US2018/040020 is a continuation-in-part of application No. 15/865,891, filed on Jan. 9, 2018.
Application No. 15/865,891 is a continuation-in-part of application No. 15/783,138, filed on Oct. 13, 2017.
Application No. 15/783,138 is a continuation-in-part of application No. 15/636,241, filed on Jun. 28, 2017.

(51) Int. Cl. G06Q 50/06; G06Q 30/02; G07F 15/00

(52) U.S. Cl. CPC G06Q 50/06; G07F 15/001; G06Q 30/0237

(57) ABSTRACT

An improved gas discount system enables discount membership companies to provide gasoline to subscribing members at discounted retail prices at virtually any participating retail gas station. At the time of prepayment, a discounted wholesale price component per gallon, negotiated between the discount membership company and the gas wholesaler, is locked in at the selected retail gas station for a selected grade of gas up to the dollar amount of the prepayment. The discounted retail price per gallon is based on the discounted wholesale gas price component per gallon at the selected station for a selected grade of gas at the time of prepayment. The gas discount system can also be used for grades of gas and retail gas stations other than those selected at the time of prepayment. In that case, the discounted retail gas price is based on a discounted wholesale gas price component per gallon at the time of delivery.

### CROSS REFERENCE TO RELATED APPLICATIONS

This application is a continuation-in-part U.S. application Ser. No. 16/136,505, filed on Sep. 20, 2018, which is a continuation-in-part of International Patent Application PCT/US18/040020, filed on Jun. 28, 2018, which is a continuation-in-part of the following U.S. patent application Ser. Nos.: 15/865,891, filed on Jan. 9, 2018; 15/783,138, filed on Oct. 13, 2017; and 15/636,241, filed on Jun. 28, 2017.

### BACKGROUND OF THE INVENTION

### 1. Field of the Invention

The present system relates to a gas discount system that is processed by a fuel dispenser based upon a prepaid gas card available by subscription from a discount membership company that virtually extends the locations and times that gas can be provided at a discount. Prior to the invention, gasoline is one of the few products that could not be purchased online.

### 2. Description of the Prior Art

Gas discount cards are known that provide a fixed discount on the retail gas price per gallon to increase sales. The retail gas price is a composite price based upon several price components. These components include; the wholesale gas cost per gallon; federal, state and local taxes per gallon; and local fees per gallon. Local fees include various components including the retail owner's expenses and profit margin.

Each of these price components normally vary by location as a percentage or discretionary discount at different retail locations. Due to these variances, fixed retail gas discounts cannot be implemented as effectively as a percentage discount of the wholesale price component. Since local taxes and various local fees cannot be discounted, any discounts normally come out of the profit on the retail price per gallon.

Gas wholesalers, on the other hand, are known to operate over relatively large regions of the country where the retail gas price components vary substantially. Any discounts provided by the wholesaler on the retail price per gallon of a gallon of gas are normally credited back to the purchaser. Assuming the wholesale gas price across the operating region varies, the wholesaler's profit margin will vary. Thus, fixed discounts on the retail price per gallon are only optimum for oil companies in regions if the wholesale price per gallon is similar.

Known discount membership companies, such as, Sam's Club and Costco, offer discounted gas prices at the retail gas stations associated with their retail locations. These discount membership companies are able to offer discounted gas prices based upon discounted wholesale prices per gallon received from wholesalers. Purchase of gas at these associated gas stations is limited to members who pay a subscription fee. These discount membership companies provide gasoline at discounts only at gas retail stations associated with their retail stores. Since these discount membership companies have limited locations and limited hours of operation, their availability of discounted gas prices is limited.

Thus, there is a need for wholesalers to be able to provide a discount on the retail price of a gallon of gas that is not limited to specific locations because the wholesale price per gallon is not similar, so the discount should not be fixed.

### SUMMARY OF THE INVENTION

An improved gas discount system enables discount membership companies with associated retail gas stations to provide gasoline at discounted retail prices at virtually any retail gas station. The gas discount system is available to consumers by way of a subscription that provides a retail gas per gallon discount at participating retail gas stations. In this system, the discount membership company negotiates discounts on the wholesale gas price per gallon with one or more wholesalers at participating retail gas stations. A subscriber prepays for gas for future delivery and receives a discount at one participating retail gas station, selected by the subscriber, for a selected grade of gas. At the time of pre-payment, a discounted wholesale price per gallon, negotiated between the discount membership company and the gas wholesaler, is locked in at the selected retail gas station for a selected grade of gas up to the amount of the prepayment. The discounted retail price per gallon is based on the discounted wholesale gas price per gallon at the selected station for a selected grade of gas at the time of prepayment. The gas discount system can also be used for grades of gas and retail gas stations other than those selected by the consumer at the time of pre-payment. In that case, the discounted retail gas price is based on a discounted wholesale gas price per gallon at the time of delivery. Alternatively, the discounted retail gas price can be based on a snapshot of discounted wholesale price components at retail gas stations in a region at the time of prepayment.

A major advantage for discount membership companies is that the improved gas discount system can be used at virtually any retail gas station, which is part of the program, thus providing more retail gas station locations with longer hours of operation than known discount membership companies, that normally are open from 9:00 am to 9:00 pm and closed on holidays.

Another advantage is that in addition to increased revenue, the wholesale gas discount card system allows a wholesaler to control different elastic demand curves. The first elastic demand curve relates to sales of gasoline. In order to increase sales, the wholesaler can increase the wholesale price discount component discount. As the demand increases, the wholesaler can lower the discount. The second elastic demand curve relates to the subscription price. In order to increase the number of subscribers, the annual fee can be lowered. As the demand to subscribe increases, the annual subscription price can be increased.

### DESCRIPTION OF THE DRAWING

These and other advantages of the present invention will be readily understood with reference to the following specification and attached drawing wherein:

FIG. 1 is an elevation view of an exemplary fuel dispenser.

FIG. 2A is a block diagram of an exemplary system for implementing the fuel dispensers disclosed herein.

FIG. 2B is a block diagram of the fuel dispenser and a central server which illustrates the data flow between the two.

FIG. 3 is a simplified exemplary flow chart of the gas discount system disclosed herein.

FIGS. 4A and 4B illustrate a Table of crude oil costs in various locations at a fixed point of time.

FIG. 5A is an exemplary flow chart for the fuel dispenser disclosed herein.

FIGS. 5B and 5C illustrate an exemplary flow chart for the remote server described herein.

FIG. 6A is an exemplary flow chart that illustrates setting up an initial account.

FIG. 6B is an exemplary flow chart that illustrates accessing an existing account.

FIG. 6C is an exemplary flow chart that illustrates optional account allocation options.

FIG. 7 is illustrative diagram of exemplary account allocation baskets.

### DETAILED DESCRIPTION

An improved gas discount system enables discount membership companies to provide gasoline at discounted retail prices at virtually any retail gas station. This system allows discount membership companies to expand the availability of gas for consumption at virtually any retail gas station. The gas discount system is available to consumers by way of a discount membership subscription that provides a retail gas per gallon discount at participating retail gas stations. A subscriber prepays for gas for future delivery and receives a discount at one participating retail gas station and a selected grade of gas, selected by the subscriber. At the time of pre-payment, a discounted wholesale price component per gallon, negotiated between the discount membership company and the gas wholesaler, is locked in at the selected retail gas station for a selected grade of gas up to the dollar amount of the prepayment. The discounted retail price per gallon is based on the discounted wholesale gas price per gallon at the selected station for a selected grade of gas at the time of prepayment. The gas discount system can also be used for grades of gas and retail gas stations other than those selected by the consumer at the time of pre-payment. In that case, the discounted retail gas price is based on a discounted wholesale gas price per gallon at the time of delivery. Alternatively, the discounted retail gas price can be based on a snapshot of discounted retail price components at retail gas stations in a region at the time of prepayment, as discussed in detail in US Patent Application Publication No. US 2017/0364896, hereby incorporated by reference.

Subscribers are provided with a gas discount card, e.g., a discount membership gift card, which may be refillable, or discount membership company credit card. The gas discount card is read by an input device, such as a magnetic card reader, at the fuel dispenser. After the gas discount card is inserted into the fuel dispenser, the system processes the discount at a discounted retail price per gallon.

The improved gas discount system may be used for purchasing one or more of the following grades of gas:
regular grade
midrange grade
premium grade
diesel grade

The improved gas discount system includes a fuel dispenser with a reconfigured control system. The reconfigured control system enables the fuel dispenser to accept a prepaid discount gas card and determine a discounted retail price per gallon based on the discounted wholesale gas price per gallon. The control system checks the subscriber's account to determine the subscriber's selected grade of gas and the selected location of a retail gas station. For gas delivery at the selected retail station and the selected grade of gas, the discounted retail price per gallon is determined based upon the discounted wholesale price per gallon at the selected retail station at the time of prepayment. This wholesale price per gallon is locked in at the time of prepayment. For other gas deliveries at other grades of gas and other retail stations, the retail price per gallon is based upon the discounted wholesale price per gallon at that station at the time of delivery. Alternatively, the discounted retail gas price can be based on a snapshot of discounted retail price components at retail gas stations in a region at the time of prepayment.

As used herein, the following definitions apply:
Undiscounted retail gas price per gallon: This is the price that a gas retailer sells a gallon of gas to a customer at a given retail location.
Undiscounted wholesale price per gallon: This is the wholesale price component of a retail gallon of gas at a given retail location.
Discounted wholesale price component: This is the discounted wholesale price component of the retail fuel price.

The discounted retail price per gallon is determined as set forth below.
Undiscounted retail price per gallon=undiscounted wholesale price per gallon+local fees per gallon+local taxes per gallon.
Discounted retail price per gallon=undiscounted retail price per gallon−the undiscounted wholesale price per gallon+the discounted wholesale price per gallon.

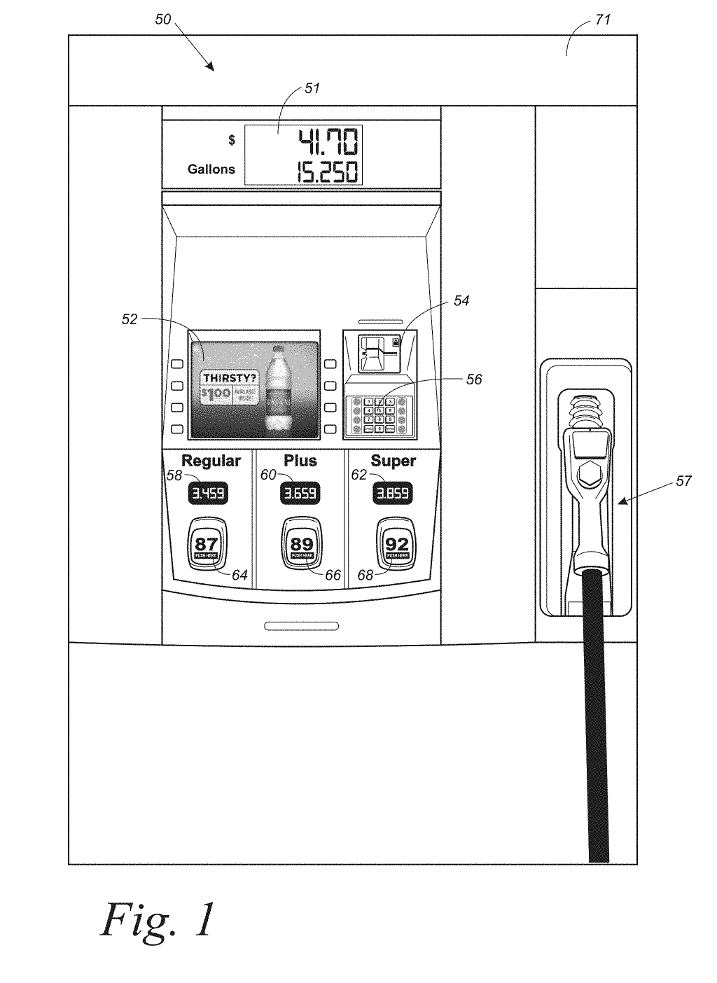

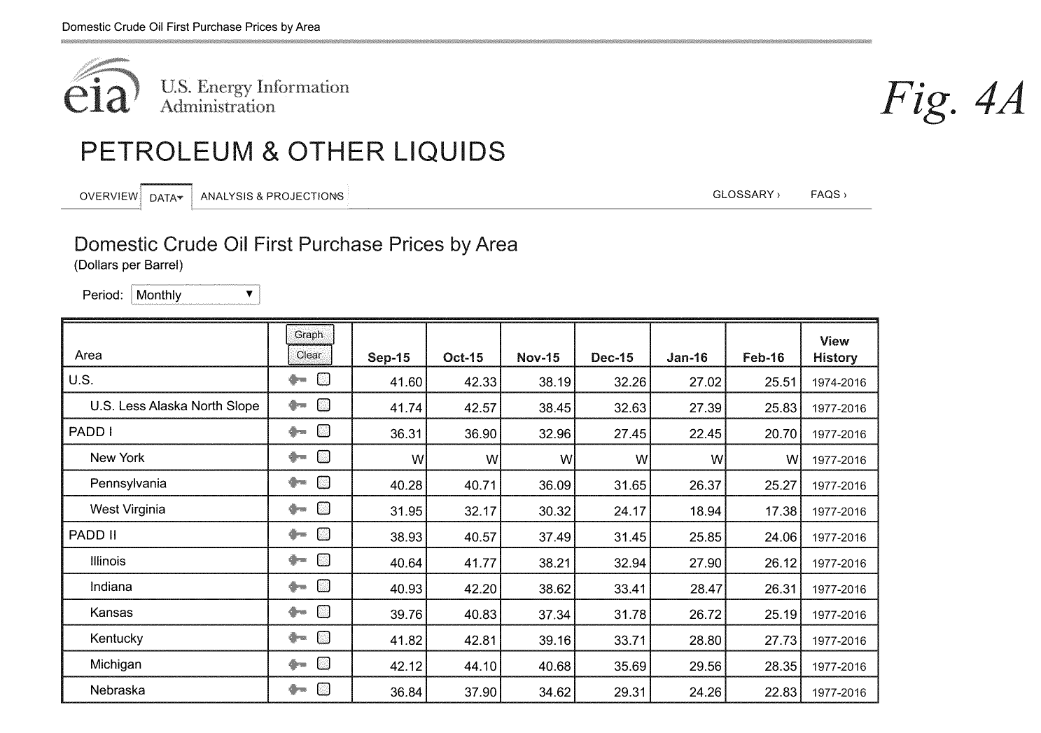

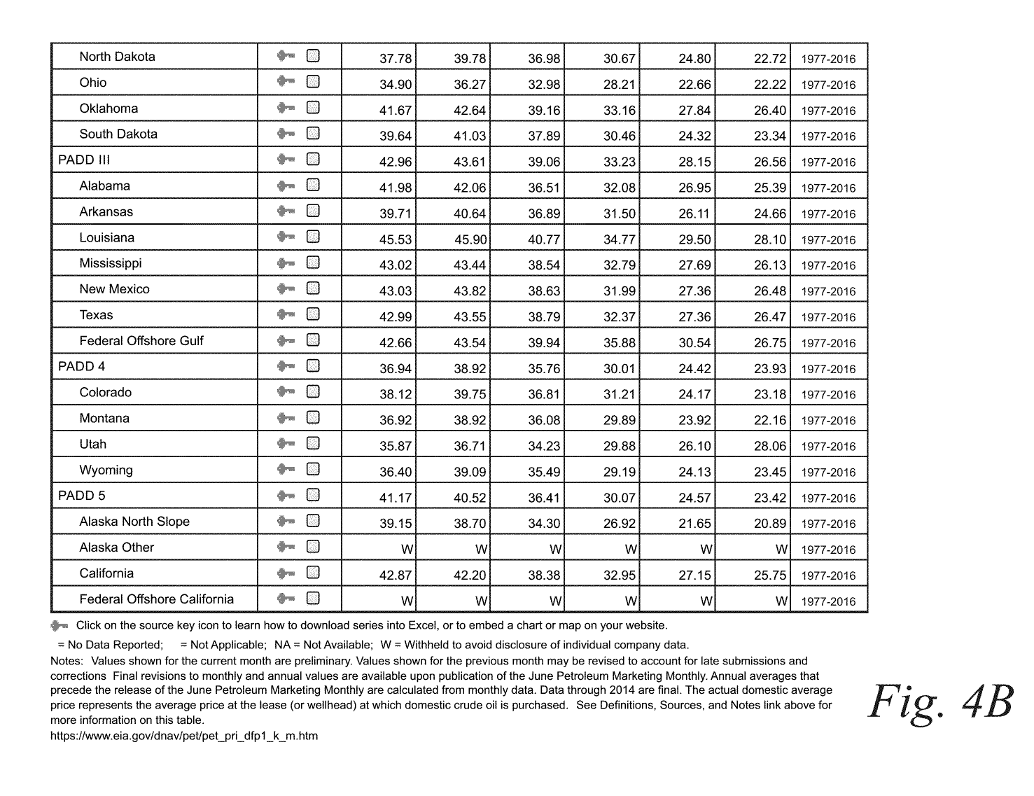

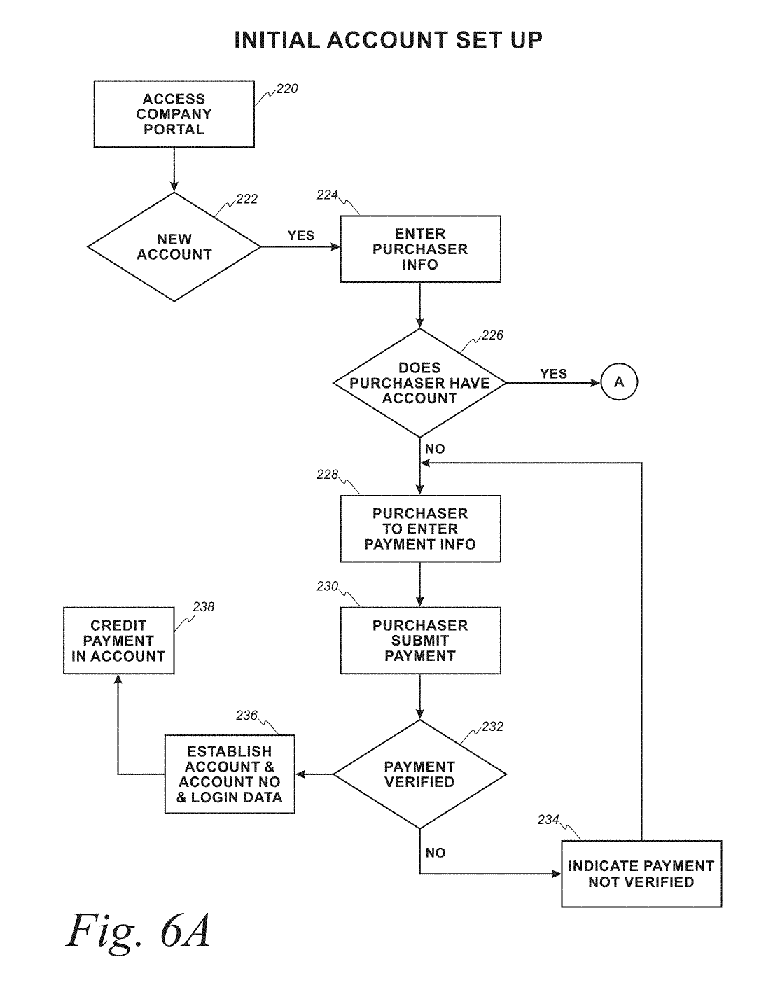

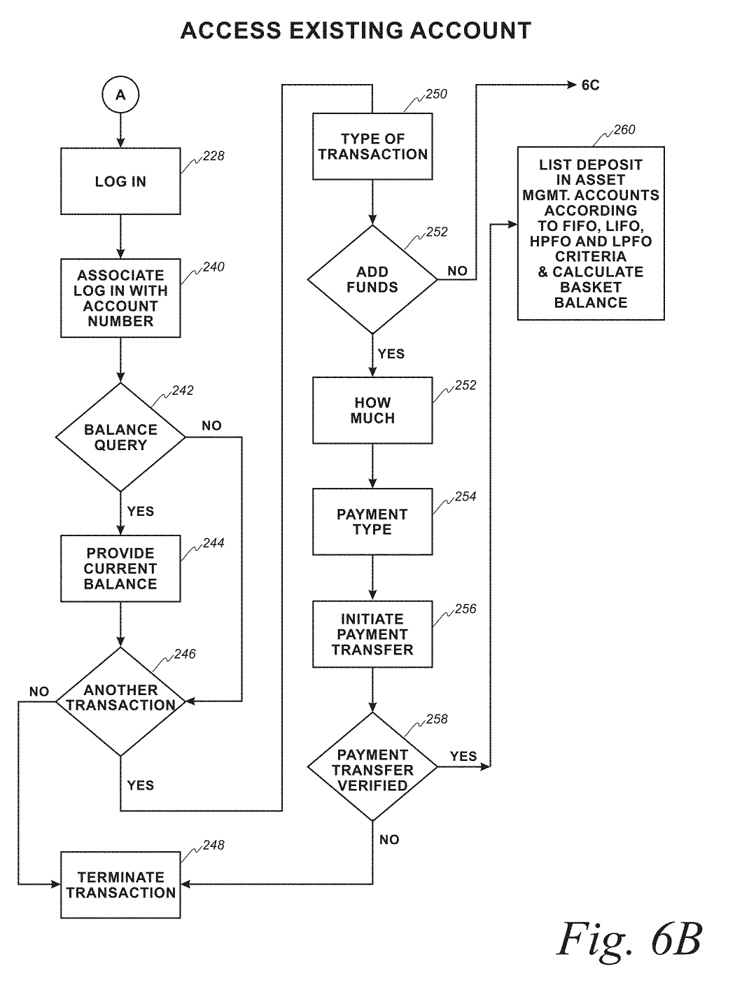

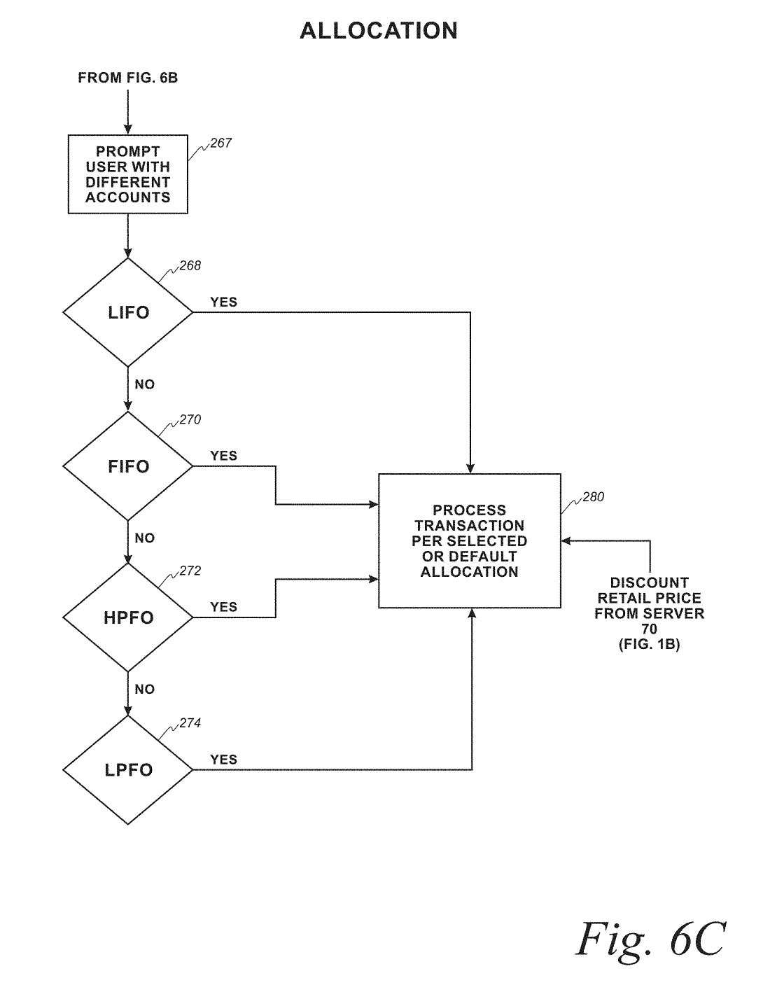

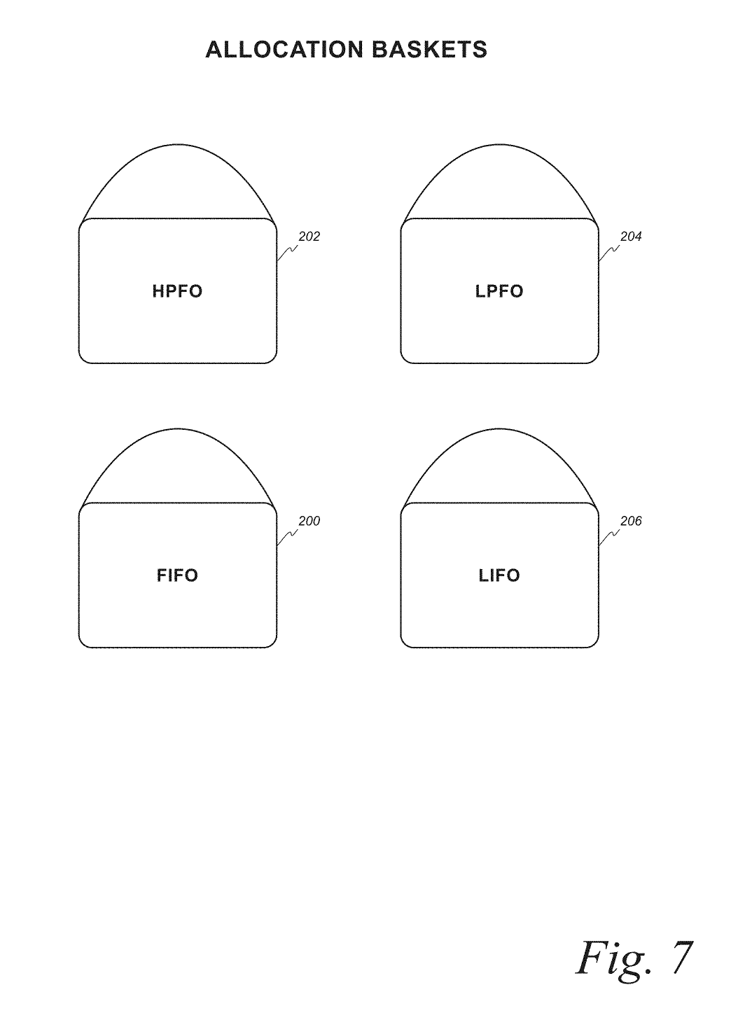

FIGS. 1-3 and 5A-5C illustrate a fuel dispenser that can process a prepaid gas discount card, as described above. FIGS. 4A and 4B illustrate domestic crude prices by location at a point in time. FIGS. 6A-7 illustrate a system in which additional prepayments can be stored in different accounts as set forth below, selectable by the purchaser.

When the gas discount card is read by an input device at the fuel dispenser, the purchaser's account data is transmitted to a central server along with the location of the fuel dispenser, the grade of gasoline selected, the current retail price per gallon. The central server performs “back office” processing and determines a discounted retail price gallon based upon a discounted wholesale price per gallon at the selected retail station that was locked in for a specific grade at the time of prepayment. The central server also determines a maximum dollar amount that can be pumped at the discounted retail price per gallon based on the purchaser's account balance and sends an enable signal to the fuel dispenser to enable fuel to be pumped up to the maximum dollar amount calculated. Once the transaction is complete or the maximum dollar amount has been reached, the central server disables the pump and debits the purchaser's account.

### Description of a Fuel Dispenser

An exemplary fuel dispenser is illustrated in FIG. 1. The fuel dispenser, generally identified with the reference numeral 50, includes a main display 51 for displaying the number of gallons pumped and the cost of the transaction. An optional display 52 may be provided for advertising. The fuel dispenser 50 also includes a first input device, such as, a magnetic card reader 54, for reading the purchaser's account information. A second input device in the form of a keyboard 56 is provided for typing in passwords, such as zip codes. The fuel dispenser may also include three price displays 58, 60 and 62 and three corresponding paddles 64, 66 and 68 for selecting a grade of gas. All of these devices are carried by a common free-standing housing 71. The fuel dispenser 50 may incorporate similar mechanical and electric hardware as disclosed in U.S. Pat. Nos.: 7,948,376; 9,302,899; 9,139,414; and 9,082,248, hereby incorporated by reference.

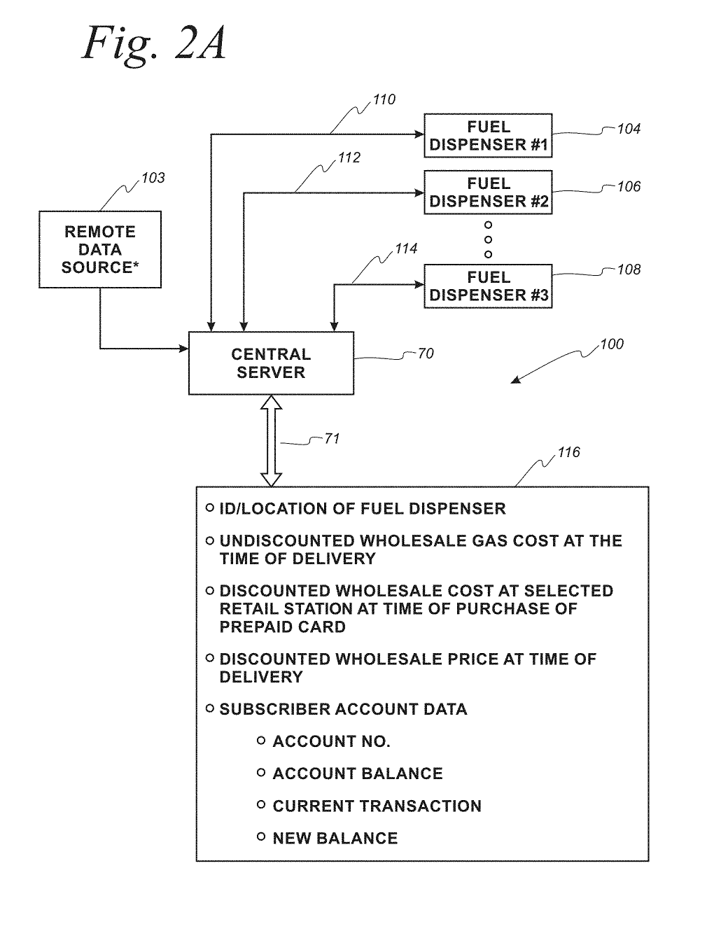

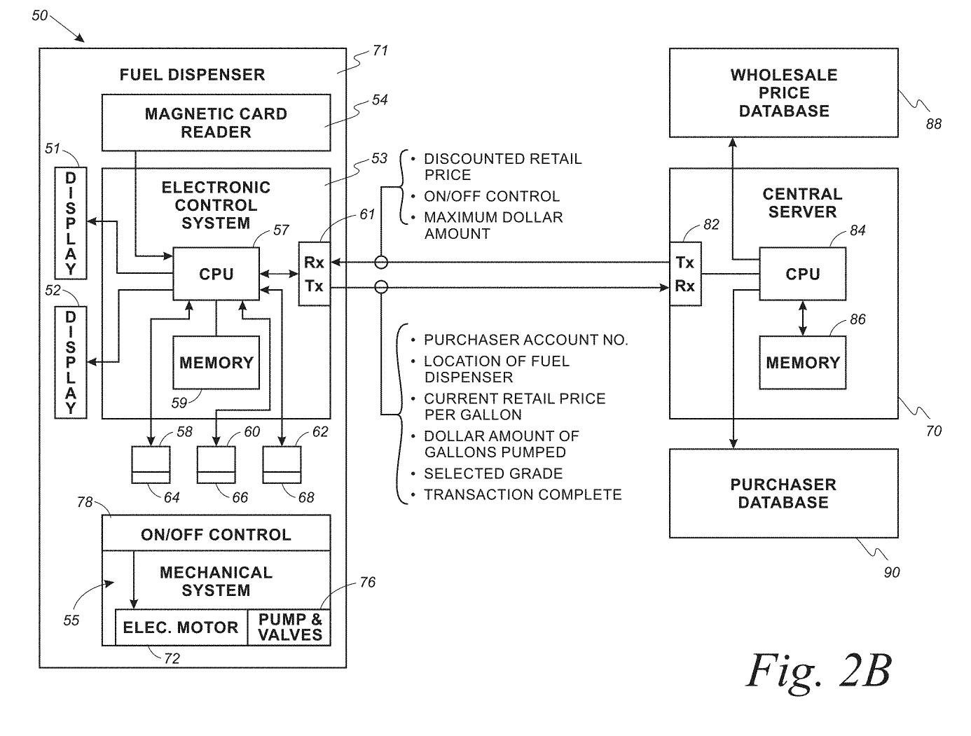

An exemplary embodiment of a system for implementing fuel dispensers with enhanced functionality as described herein is illustrated in FIG. 2A. The system 100 may include at least one server 70 and one or more storage devices 103 and 116 for storing a wholesale price database 88 and a purchaser database 90.

As shown, the central server 70 is in bi-directional communication with the fuel dispensers 104, 106 and 108 by way of the communication links 110, 112 and 114. A bidirectional communication link 71 is also provided between the central server 70 and a persistent storage device 116. The persistent storage device stores various data including the following:
Location of the fuel dispenser
Undiscounted wholesale gas cost at the time of delivery at retail station at the time of delivery
Discounted wholesale cost at the selected retail gas station at the time of prepayment
Subscriber account data including account no., account balance, and current transaction

FIG. 2B is a simplified block diagram of the fuel dispenser 50 and the central server 70, illustrated with the data communication signals between the two. Referring first to the fuel dispenser 50, it includes an electronic control system 53 and a mechanical system 55. The mechanical system 55 includes a pump driven by an electric motor and various control valves as known in the art, for example, as disclosed in U.S. Pat. Nos.: 7,948,376; 9,302,899; 9,139,414; and 9,082,248, hereby incorporated by reference.

The mechanical system 54 includes a motor driven pump and electric valves (not shown) under the control of the electronic control system 53. The electronic control system 53 includes control logic as used in conventional fuel dispensers and further includes the logic disclosed below to provide enhanced functionality of the fuel dispenser 50. The electronic control system 53 includes a CPU and memory.

The electronic control system 53 transmits the following data to the central server 70:
Purchaser account no.
Location of fuel dispenser
Current retail price per gallon
Number of gallons pumped
Selected grade
Transaction complete

The central server 70 uses that data to calculate the discounted retail fuel price per gallon based upon a discounted wholesale price per gallon. If the gas is being delivered at a retail station and grade preselected by the consumer, the discounted retail gas price per gallon is based on the discounted wholesale gas price at the time the prepaid fuel discount card was purchased. If the grade and retail gas station location are other than those preselected by the subscriber, the discounted retail price per gallon is based upon the discounted wholesale price per gallon at fuel dispenser at the time of delivery.

The discounted retail price per gallon may be used to the drive various displays on the fuel dispensers 104, 106 . . . 108 including the retail price per gallon displays 58, 60 and 62 for the various grades of fuel as well as the display 51 that displays the number of gallons pumped and the total cost therefor.

Based upon the purchaser's available account balance or available credit, the central server 70 determines the maximum dollar amount that can be dispensed using the discounted retail gas price and enables the electric motor 72 and the electrically controlled valves under the control of the hand-operated lever in the nozzle up or the maximum dollar amount. Should the maximum dollar amount be reached before the hand operated lever in the nozzle is released, the central server 70 will send an off signal to the on/off control 78 to turn off the pump 74 off at the maximum dollar amount. Alternatively, the pump 74 can be turned off when a desired dollar amount is reached or the purchaser's tank is full.

Based on the discounted retail price per gallon, the central server 70 calculates the maximum dollar amount that can be pumped based upon the discounted retail price per gallon and the current balance in the purchaser's account.

The central server 70 transmits the following data to the fuel dispenser 104, 106 . . . 108, where delivery is taken:
On/off control of the pump based on maximum dollar amount
Discounted retail price per gallon

After gasoline dispensing is terminated, either by the purchaser or automatically when the purchaser's gas tank is full, or when the maximum dollar amount is reached, the fuel dispenser 104, 106 . . . 108 may send a transaction complete signal back to the central server 70. Upon receipt of that signal, the central server 70 adjusts the purchaser's account balance based upon the dollar amount of the gas pumped and the discounted unit retail price. The revised balance is stored by the central server 70 in the purchaser's account database 90 (FIG. 2B). The purchaser's account is subsequently debited for the dollar amount of the gas pumped.

As shown in FIG. 2B, the electronic control system 53 includes a computer processing unit (CPU) or microcontroller 57 (FIG. 2B) and memory 59 which may include persistent memory as well as random access memory (RAM). The electronic control system 53 also includes a transceiver 61 for providing a bidirectional communication path with a remote server 70.

The central server 70 includes a transceiver 82 for communicating with the transceiver 61 on the fuel dispenser 50. It is to be understood that the communication between the fuel dispenser 50 and the central server 70 may not be direct as shown. Other communication configurations are contemplated. The direct communication path illustrated in FIG. 2B between the fuel dispenser 50 and the central server is provided for simplicity.

The central server 70 includes a CPU or microcontroller 84 and memory 86, such as RAM memory and persistent memory. The central server 70 is provided with access to a wholesale price database 88 and a purchaser's account database 90 (FIG. 2B). The central server 70 is in bi-directional communication with a data source 103 and a storage device 116. The database 116 includes data as discussed above. An external data source 103 may also be provided for storing wholesale price per gallon data, such as the local wholesale gas price per gallon for various grades of gas for retail gas stations across an entire region

### Flow Charts

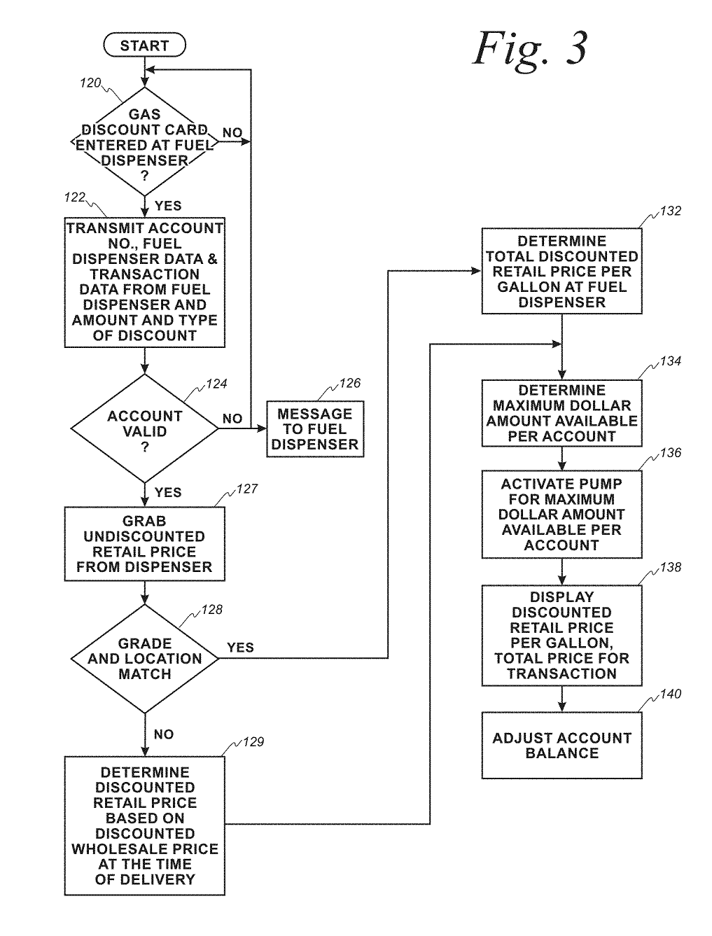

A simplified flow chart of the improved gas discount system is illustrated in FIG. 3. It is to be understood that the improved functionality of the fuel dispenser is not limited to the sequence of steps set forth in FIG. 3. The process may be executed in different sequences to reach the end results, discussed above.

The system waits in step 120 for a prepaid gas card to be read by an input device, such as the card reader 54 (FIG. 1). Once the prepaid gas card is read, the purchaser's account number along with the transaction data and the fuel dispenser data, i.e., fuel pump location, is sent to the central server 102 in step 122. The system then determines if the purchaser account is valid in step 124. If the account is not valid, the system returns to step 120 and waits for another prepaid gas card to be read at the POS terminal 104, 106 and 108. A message, such as “Account Not Valid”, may optionally be displayed by the display 52 (FIG. 1) in step 126.

If the purchaser's account is valid, the system grabs the retail price per gallon from the fuel dispenser 104, 106 and 108 in step 127. The system proceeds to step 128 to determine if the grade and location at delivery match those selected at the time the gas card was purchased. If the grade and location matches the purchaser's selections at the time of prepayment, the system proceeds to step 132 and determines the discounted retail price per gallon based on the discounted wholesale price per gallon at the time of purchase of the gas card. If the grade and the location of the retail gas station do not match, the selections by the subscriber at the time of purchase of the gas card, the system proceeds to step 129 and determines the discounted retail price per gallon based on the discounted wholesale gas price per gallon at the time of delivery.

Once the discounted retail gas price is determined, the system proceeds to step 134 to determine the maximum dollar amount of gas that can be purchased based upon the discounted retail gas price per gallon and the credit balance in the purchaser's account. In step 136, the central server 102 signals the pump at the fuel dispenser to turn on. Once the pump is turned on, the central server 102 provides signals to the fuel dispenser 104, 106 and 108 to display the adjusted price per gallon, total cost of the transaction and the maximum dollar amount of the gas pumped in step 138. The purchaser's account balance is adjusted and stored by the server 102 in step 140. The fuel dispenser 50 will allow the pump to stay on up to the maximum dollar amount. Once the pumped gas reaches the maximum dollar amount, the central server 102 sends a signal to the POS terminal to turn it off.

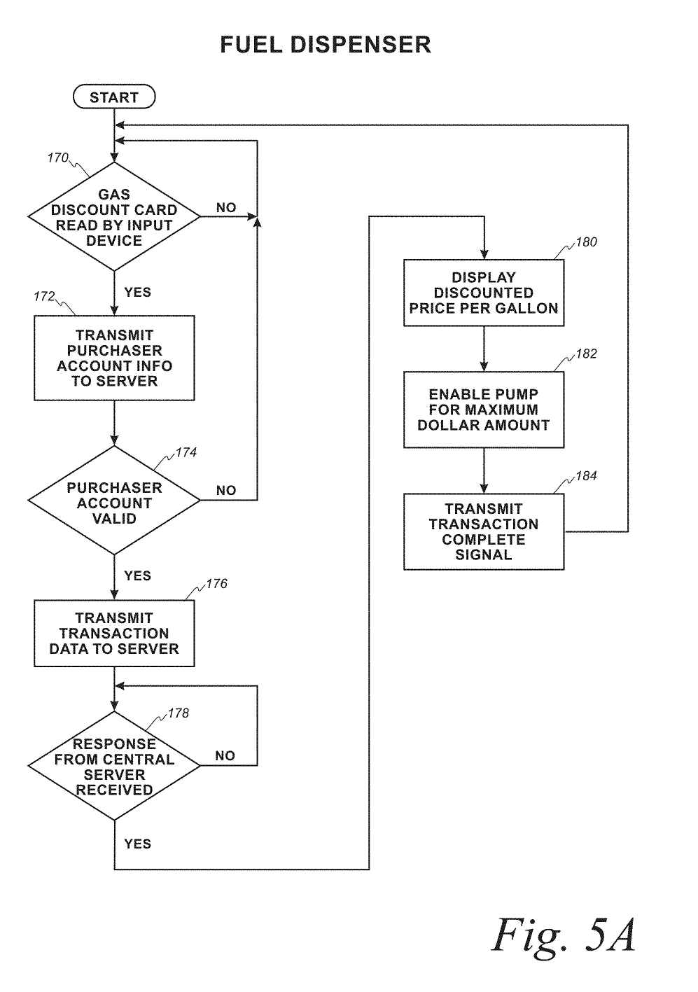

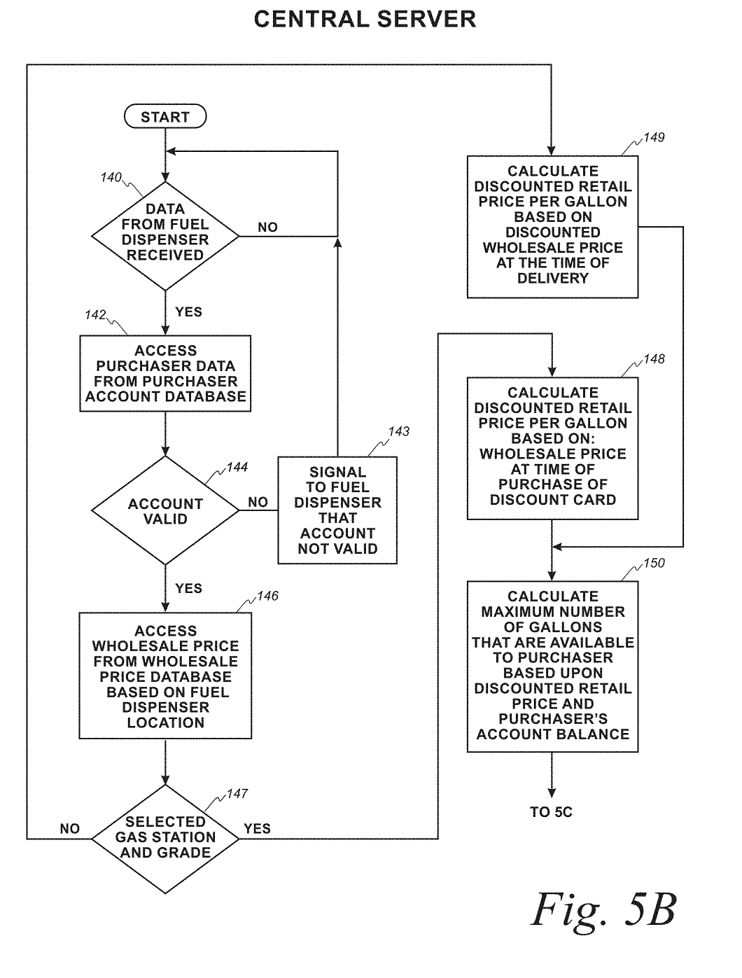

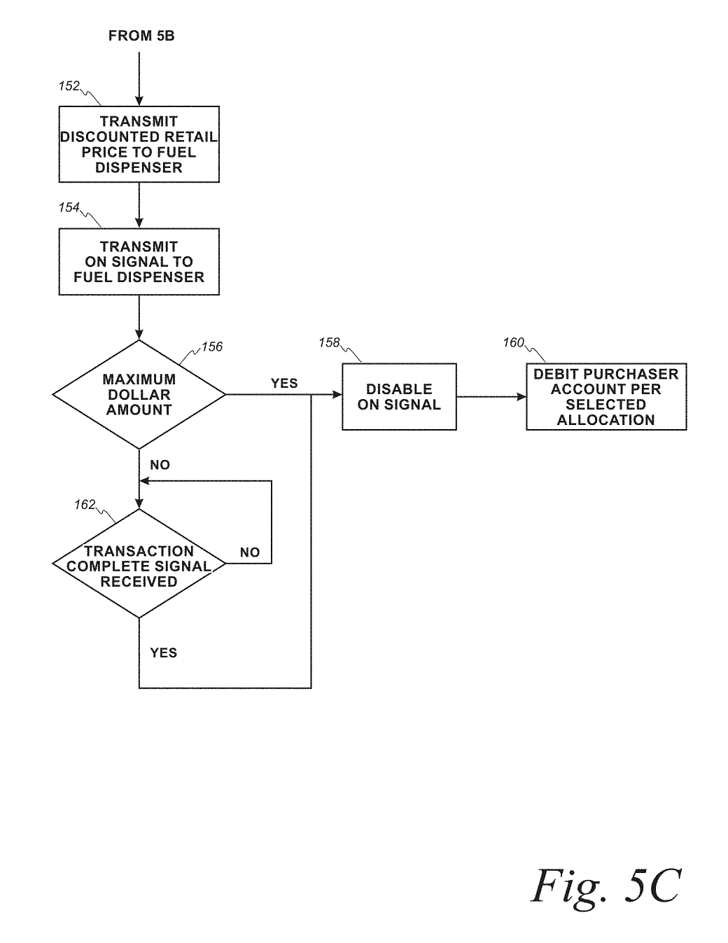

An exemplary flow chart for a fuel dispenser 104, 106 and 108 is illustrated in FIG. 5A. Initially, the system waits in step 170 for a prepaid gas discount card to be received by an input device, such as, a magnetic card reader 54 (FIG. 1) and read. Once the gas discount card is read by the CPU 57, the purchaser's account data is sent to the central server 70 by way of the transceiver 61 in step 172 (FIG. 2B). This account information is received by the transceiver 82 at the central server 70. The CPU 84 at the central server 70 reads the account number and checks in step 174 to determine whether the purchaser's account is valid. If the purchaser's account is not valid, the central server 70 signals the electronic control system 53 (FIG. 2B) at the fuel dispenser that the purchaser's account is not valid and returns to step 170 and awaits another prepaid fuel discount card to be read by the input device on the fuel dispenser 50 (FIG. 1).

If the purchaser's account is valid, the CPU 57 at the fuel dispenser 50 awaits this response from the central server 70 (FIG. 2A) in step 178. Once a response is received from the central server 70 that the purchaser's account is valid, the fuel dispenser 50 displays the discounted retail gas price per gallon in step 180. Once the fuel dispenser 50 receives a turn on pump signal from the central server 70, the electric motor 72 and electrically controlled valves 76 (FIG. 2B) are enabled up to maximum dollar amount based upon the discounted retail fuel price and the balance in the purchaser's account in step 182. Once the manual lever in the handle 57 is released or an automatic shutoff is sensed, or the maximum dollar amount is reached, the electronic control system 53 transmits a transaction complete signal to the central server 70 in step 184 and subsequently returns to step 170.

An exemplary flow chart for the central server 70 is illustrated in FIGS. 5B and 5C. Initially, the central server 70 awaits purchaser account information from the fuel dispenser 50 (FIG. 1A) in step 140. Once the purchaser's account information is received, the CPU 84 looks up the purchaser's account data in the storage device 116 (FIG. 2A) in step 142 and determines if the purchaser's account is valid in step 144. If the purchaser's account is not valid, a signal indicating the same is sent to the CPU 57 (FIG. 2B) to the electronic control system 53 in step 143. The system then returns to step 140.

If the purchasers account is valid, the system checks whether the location of the retail gas station and the grade of gas match the subscriber's selections at the time of purchase of the prepaid gas discount card in step 147. If the location of the retail gas station and the grade of gas match the subscriber's selections at the time of purchase of the gas card, the system proceeds to step 148 accesses the wholesale price database 88 (FIG. 2B) to determine the wholesale price component per gallon at the time of purchase of the discount gas card. The CPU 84 calculates the discounted retail price per gallon based on the discounted whole price per gallon at the time of purchase of the gas card. The system then proceeds to step 150.

If the location of the retail station and the grade of gas do not match the subscriber's selections at the time of purchase, as determined in step 147, the system proceeds to step 149 and calculates the discounted retail price per gallon based on the discounted wholesale price per gallon at the time of delivery.

The system then proceeds to step 150. In step 150, the CPU 84 determines the maximum dollar amount of the gas that can be delivered to the purchaser based upon the discounted retail price and the balance in the purchaser's account. The discounted unit retail fuel price is transmitted to the fuel dispenser in step 152. An ON signal is transmitted to the fuel dispenser 50 to enable the on/off control subsystem 78 (FIG. 2B) to enable the electric system 55 in step 154 to turn on the gas pump.

Once the maximum dollar amount is reached; the Purchaser's desired dollar amount is reached, the server 70 sends a signal to the fuel dispenser to turn off the gas pump in step 156. Alternatively, if the transaction is terminated at the fuel dispenser end by the subscriber or by an automatic shut off based upon the gas tank being full, the fuel dispenser issues a transaction complete signal to the server 70 in step 162. Upon receipt of the transaction complete signal or a signal that the maximum dollar amount has been reached, the CPU 70 issues a turn off signal to the fuel dispenser 50 in step 158. In step 160, the system debits the purchaser's account for the dollar amount of the gas pumped. The total number of gallons pumped and total price as well as the discounted price per gallon are displayed at the fuel dispenser.

### Optional Embodiments

FIGS. 6A-6C and 7 illustrate an optional aspect of the invention which relates to allocation of funds in the purchaser's account once the purchaser makes deposits to their account after the initial deposit. The best way to explain the concept is by example. Suppose the purchaser initially deposits $500 in their prepaid gas discount card account and gets a locked-in wholesale component price at a reference location after the discount is applied of $2.00 per gallon. Now consider the purchaser decides to add additional money to the account before his initial deposit is completely depleted. At the time of the second deposit, the purchaser gets a locked in wholesale component price of $2.50 per gallon after the discount is applied at the reference location. Clearly gasoline delivered debited from the second deposit would be more expensive to the purchaser than from the first deposit.

The deposits are associated with different asset management accounts or baskets 200-206 with different criteria (FIG. 7). These baskets allow a user to specify the basket to be debited for each gas delivery. Each deposit is associated with all four baskets at the same time according to the criteria below. At all times, each basket has the same deposits and the total amount of cash in all baskets is the same. Each basket is defined below.
“First in First out” (FIFO)—All deposits are associated with a FIFO basket 200 in the order that the deposits are made.
“Last in First out “(LIFO)—The deposits in this basket are the same as the deposits in the FIFO basket in reverse order of the deposits in the FIFO
Highest Prepaid First out” (HPFO)—This basket 202 is based on a deposit for the highest locked in wholesale component price after the discount is applied at a reference location and first consumed.
“Lowest Prepaid First out” (LPFO)—This basket 204 is based on a deposit for the lowest locked in wholesale component price after the discount is applied at a reference location and first consumed.

The best way to understand the asset management accounts is by way of the examples below. These examples are based upon the cost of premium at a station at 307 East 89th Street in New York City.

Example 1 is based on four deposits and two purchases and is illustrated in the tables below. As shown below in Example 1, deposits were made on January 3, March 11, May 25 and July 4. As shown, the discounted retail price for each deposit varies from $2.30 to $2.60 per gallon. These deposits are grouped in all four baskets 200-206 by different criteria; namely FIFO, LIFO, HPFO and LPFO, each of which forms an asset management account. At each gasoline delivery, the user can designate the asset management account to be debited for the gasoline.

### EXAMPLE 1

| FIFO | LIFO | HPFO | LPFO |
|---|---|---|---|
| Jan 3 | July 4 | May 25 | March 11 |
| $250@ | $250@ | $300@ | $150@ |
| 2.50 | $2.40 | $2.60 | $2.30 |
| March 11 | May 25 | Jan 3 | July 4 |
| $150@ | $300@ | $250@ | $250@ |
| $2.30 | $2.60 | 2.50 | $2.40 |
| May 25 | March 11 | July 4 | Jan 3 |
| $300@ | $150@ | $250@ | $250@ |
| $2.60 | $2.30 | $2.40 | 2.50 |
| July 4 | Jan 3 | March 11 | May 25 |
| $250@ | $250@ | $150@ | $300@ |
| $2.40 | 2.50 | $2.30 | $2.60 |
| Basket | Basket | Basket | Basket |
| Total | Total | Total | Total |
| $900 | $900 | $900 | $900 |
| Basket | Basket | Basket | Basket |
| 200 | 206 | 202 | 204 |

Example 2 illustrates a $50 delivery of premium on August 1 using a debit from the HPFO basket 202.

### EXAMPLE 2

| FIFO | LIFO | HPFO | LPFO |
|---|---|---|---|
| Jan 3 | July 4 | May 25 | March 11 |
| $250@ | $250@ | $250@ | $150@ |
| 2.50 | $2.40 | $2.60 | $2.30 |
| March 11 | May 25 | Jan 3 | July 4 |
| $150@ | $250@ | $250@ | $250@ |
| $2.30 | $2.60 | 2.50 | $2.40 |
| May 25 | March 11 | July 4 | Jan 3 |
| $250@ | $150@ | $250@ | $250@ |
| $2.60 | $2.30 | $2.40 | 2.50 |
| July 4 | Jan 3 | March 11 | May 25 |
| $250@ | $250@ | $150@ | $250@ |
| $2.40 | 2.50 | $2.30 | $2.60 |
| Basket | Basket | Basket | Basket |
| Total | Total | Total | Total |
| $850 | $850 | $850 | $850 |
| Basket | Basket | Basket | Basket |
| 200 | 206 | 202 | 204 |

In example 2, since the HPFO basket was selected to be debited for the $50 delivery of gas, the May 25 deposit being the highest was decreased by $50 in all four baskets 200-206.

Example 3 illustrates a $40 delivery using a debit from the LPFO basket 204

### EXAMPLE 3

| FIFO | LIFO | HPFO | LPFO |
|---|---|---|---|
| Jan 3 | July 4 | May 25 | March 11 |
| $250@ | $250@ | $250@ | $110@ |
| 2.50 | $2.40 | $2.60 | $2.30 |
| March 11 | May 25 | Jan 3 | July 4 |
| $110@ | $250@ | $250@ | $250@ |
| $2.30 | $2.60 | 2.50 | $2.40 |
| May 25 | March 11 | July 4 | Jan 3 |
| $250@ | $110@ | $250@ | $250@ |
| $2.60 | $2.30 | $2.40 | 2.50 |
| July 4 | Jan 3 | March 11 | May 25 |
| $250@ | $250@ | $110@ | $250@ |
| $2.40 | 2.50 | $2.30 | $2.60 |
| Basket | Basket | Basket | Basket |
| Total | Total | Total | Total |
| $810 | $810 | $810 | $810 |
| Basket | Basket | Basket | Basket |
| 200 | 206 | 202 | 204 |

In example 3, since the LPFO basket was selected to be debited for the $40 delivery of gas, the March 11 deposit being the lowest was decreased by $40 in all four baskets 200-206.

After the four deposits, the user started off with $900. After the $50 delivery, the balance dropped to $850. After the $40 delivery, the balance dropped to $810 even though different cash management accounts were used for each purchase.

Exemplary flow diagrams are illustrated in FIGS. 6A-6C for implementing the optional allocation aspect of the invention. Turning first to FIG. 6A, an exemplary method of setting up the asset management accounts is illustrated. Various methods are contemplated for setting up account. One such method is by way of a web-based portal 200. The portal allows purchasers to set up the asset management accounts, make deposits and adjust their allocation option as desired, for example by way of any Internet connected computing device, such as a smart phone.

Turning to FIG. 6A, a subscriber accesses the company portal in step 220. After the portal is accessed, the user is prompted whether a new account is being opened in step 222. If so, the purchaser's demographic data is entered in step 224. Next, the system checks in step 226 whether the purchaser already has an account. If so, the purchaser is requested to log in to their existing account in step 228 (FIG. 6B). If not, the purchaser is requested to enter payment information in step 228 for the first deposit, by credit card or debit card, etc. and submit payment in step 230.

The system verifies the payment in step 232. If the payment is not verified, the system may post a note in step 234 indicating that the payment was not verified and return to step 228. If the payment is verified, the system proceeds to step 236 to establish account number and interactively set up log in credentials with the purchaser. The system then credits the initial payment which is credited to all four asset management accounts 200-206, as shown below. For example, assume the user makes an initial $350 payment and locks in the discounted retail gas price at $2.10. See Example 4 below. The deposit is listed in all four asset management accounts 200-206.

### EXAMPLE 4

| FIFO | LIFO | HPFO | LPFO |
|---|---|---|---|
| $350 @ | $350 @ | $350 @ | $350 @ |
| $2.10 | $2.10 | $2.10 | $2.10 |
| Basket | Basket | Basket | Basket |
| Total | Total | Total | Total |
| $350 | $350 | $350 | $350 |
| Basket | Basket | Basket | Basket |
| 200 | 206 | 202 | 204 |

Next assume the user makes a second deposit of $250 and locks in a discounted retail gas price at $2.50. See Example 5 below.

### EXAMPLE 5

| FIFO | LIFO | HPFO | LPFO |
|---|---|---|---|
| $350 @ | $250 @ | $250 @ | $350 @ |
| $2.10 | $2.50 | $2.50 | $2.10 |
| $250 @ | $350 @ | $350 @ | $250 @ |
| $2.50 | $2.10 | $2.10 | $2.50 |
| Basket | Basket | Basket | Basket |
| Total | Total | Total | Total |
| $600 | $600 | $600 | $600 |
| Basket | Basket | Basket | Basket |
| 200 | 206 | 202 | 204 |

In Example 4, the initial deposit is listed in all four asset management accounts 200-206. When subsequent deposits are made, for example, as illustrated in Example 5, the priority of the deposits in each asset management account 200-206 is adjusted according to the criteria of each of the accounts, i.e. FIFO, LIFO, HPFO and LPFO.

FIGS. 6B and 6C illustrate exemplary flow diagrams after the initial account is established, as discussed above. Referring first to FIG. 6B, the purchaser logs onto the portal in step 228. In step 240, the system associates the log in credentials with the purchaser's account number. In step 242, the system queries whether a balance inquiry is desired. If so, the purchaser's current balance is provided in step 244. If a balance inquiry is not requested, or alternatively if the current balances were requested and provided, the system proceeds to step 246 and queries whether another transaction is requested. If not, the transaction is terminated in step 248.

If another transaction is requested, the system proceeds to step 250 and queries the type of the transaction desired by the purchaser. In step 252, the system queries whether funds are to be added. If not, the system proceeds to step 268 (FIG. 6C) and assumes that the user is specifying an asset management account 200-206 for payment of a delivery.

If the user indicates that funds are to be added, the system queries in step 252, the amount of the additional funds to be added to the account. In steps 254 and 256, the payment is initiated. In step 258, the payment transfer is verified. If it is not verified, the system proceeds to step 248 and terminates the transaction. If the payment is verified, the system proceeds to step 260 and lists the new deposit into the four asset management accounts, represented by the baskets 200-206 (FIG. 5) according to the basket criteria, i.e., FIFO, LIFO, HPFO and LPFO, as discussed above. The system also calculates the basket balance.

FIG. 6C illustrates an exemplary flow diagram for selection an asset management account. The user is prompted with the four asset management accounts for purchase in step 267. A purchaser can specify an asset management account any time before or after gas delivery, for example, by way of a smart phone. In steps 268-274, the system determines the asset management account 200-206 selected by the user for payment of a delivery. If no asset management accounts 200-206 are selected, the system may optionally use the last selected asset management account 200-206.

The selected asset management account is processed in step 280. This includes providing payment for the transaction in a conventional manner based upon the discounted retail price from the server 70 (FIG. 1B). The system also debits the selected deposit for the transaction and readjusts the balances the asset management accounts, as illustrated above.

### Embodiment 3

An optional aspect of the invention relates to a payment allocation system which enables a purchaser to make multiple prepaid deposits of different amounts at different times in which the wholesale price components may vary and pay for gas deliveries with a weighted average of those wholesale price components.

The best way to understand the payment allocation system is by way of an example below. The table below lists three deposits at different discounted retail prices. As used below, the prices refer to discounted retail costs per gallon.

| | | | Locked in | | Disc. | Wghtd. Disc. | | |
|---|---|---|---|---|---|---|---|---|
| | Date | Amt. | Whol. Price | % | Whol. | Whol. Price/ | Date | $ Amt |
| Bal. | Of Dep. | of Dep. | per Gallon | Disc. | Price | gallon | of Con. | of Con. |
| 150 | Jan. 5, 2017 | 150 | 2.50 | 20% | 2.00 | 2.00 | | |
| 110 | | | | | | 2.00 | Jan. 9, 2017 | 40 |
| 80 | | | | | | 2.00 | Jan. 15, 2017 | 30 |
| 280 | Jan. 20, 2017 | 200 | 2.80 | 25% | 2.10 | 2.0714 | | |
| 245 | | | | | | 2.0714 | Feb. 2, 2017 | 35 |
| 220 | | | | | | 2.0714 | Feb. 8, 2017 | 25 |
| 175 | | | | | | 2.0714 | Feb. 11, 2017 | 45 |
| 125 | | | | | | 2.0714 | Feb. 17, 2017 | 50 |
| 425 | Feb. 20, 2017 | 300 | 2.30 | 15% | 1.955 | 1.9892 | | |
| 381 | | | | | | 1.9892 | Feb. 21, 2017 | 44 |
| 343 | | | | | | 1.9892 | Feb. 27, 2017 | 38 |
| 301 | | | | | | 1.9892 | Mar. 1, 2017 | 42 |
| 270 | | | | | | 1.9892 | Mar. 9, 2017 | 31 |

The columns in the table are described below.
Bal.: the current balance in the user's account.
Date of Dep.: the date the user deposited funds in the account.
Amt. of Dep.: the amount of funds the user deposited into their account
Locked in Whol. Price per gallon: the locked in wholesale price component per gallon at the time of deposit for a discounted retail price.
% Disc.: the percentage per gallon discount of the wholesale price component at the time of deposit.
Disc. Whol. Price: the discounted wholesale price component in dollars.
Wghtd. Disc. Whol. Price/gallon.: the weighted average of the wholesale price components as determined at each deposit.
Date of Con.: the date of consumption or the date the user takes delivery of gas.
$ Amt. of Con. the dollar amount of consumption which includes the average weighted discounted wholesale price components per gallon +the local fees and local taxes multiplied by the number of gallons consumed.

As shown above, deposits were made on January 5, January 20 and February 20. As shown, the wholesale price components for each deposit varies the retail price from $2.30 to $2.80 per gallon. The system determines the weighted average wholesale price component per gallon after each deposit is made and discounted and uses that number to determine the discounted retail price per gallon, as discussed above. This discounted retail price per gallon may be displayed on the display 51 (FIG. 1A) along with the amount of the completed transaction. The purchaser's account is debited using this discounted retail price per gallon. When the transaction is complete, as determined by the on/off control system 78, the fuel dispenser 50 (FIG. 1B) transmits the number of gallons pumped to the server 70 to be debited from the purchaser's account and displayed on the display 51 (FIG. 1A).

Referring to the table, the average weighted wholesale price per gallon is calculated each time a deposit is made to the account. The average weighted wholesale price component for each deposit normally varies as subsequent deposits are made so the retail price will vary. With reference to the table, the average weighted wholesale price after the initial deposit is $2.00 per gallon. When the second deposit is made, $80 remained from the first deposit. Thus, the average discounted retail price per gallon at the time of the second deposit is [($80×$2.00)+($200×$2.10)]/$280 yields a weighted average discounted retail price of $2.0714 per gallon. When the third deposit is made, the user's account has a balance of $125. The average weighted discounted retail price per gallon at the time of the third deposit is [($125×$2.0714)+($300×$1.955)]/$425 yields a weighted average discounted retail price of $1.9892 per gallon.

Obviously, many modifications and variations of the present invention are possible in light of the above teachings. Thus, it is to be understood that, within the scope of the appended claims, the invention may be practiced otherwise than as specifically described above.

I claim:

1. A gas discount system for enabling a fuel dispenser to process a discount on a wholesale price per gallon component of the retail price per gallon based on the discounted wholesale price of a selected grade of gas and retail station, the system comprising:
a fuel dispenser including a mechanical system which includes an electric system and a mechanical system, the system comprising
a pump for pumping fuel;
an electric motor for driving said pump;
at least one electrically controlled valve; and
an electronic control system comprising:
an input device for reading prepaid gas discount card that provides purchaser's account information;
an on/off control subsystem for selectively enabling said electric system; and
a central server for storing purchaser account data including the purchaser's balance, and the grade and retail station location, selected by the purchaser at the time of prepayment;
a bidirectional communication subsystem for transmitting data between said central server and said fuel dispenser including the location of the fuel dispenser where fuel is being delivered, the grade being delivered, the purchaser's account information, the undiscounted retail price at the fuel dispenser where fuel is being delivered, the number of gallons pumped, said server configured to calculate a discounted retail price per gallon based on whether the grade and location of the retail station at the time of delivery match the grade and location selected by the subscriber at the time of prepayment; and transmitting the discounted retail price to the fuel dispenser and enabling the on/off control system up to the balance of the subscriber's account.

2. The gas discount system as recited in claim 1, wherein the discounted retail price is based on the discounted wholesale price per gallon at the selected retail station at the time of prepayment.

3. The gas discount system as recited in claim 1, wherein the discounted retail price is based on the discounted wholesale price per gallon at the selected retail station at the time of delivery.

4. The gas discount system as recited in claim 1, further including an asset management system includes one or more accounts for additional prepayments that allows a purchaser to designate a specific account for storing additional prepayments.
